(19) United States
(12) Patent Application Publication
(10) Pub. No.: US 2020/0338854 A1
(43) Pub. Date: Oct. 29, 2020

(54) LAMINATED GLASS STRUCTURE WITH IMPROVED WAVINESS

(71) Applicants: Jhee-mann KIM, Gyeonggi-do (KR); Joon-Soo KIM, Gyeonggi-do (KR); Goo-Soo LEE, Seoul (KR); CORNING INCORPORATED, CORNING, NY (US)

(72) Inventors: Jhee-mann Kim, Yongin-Si (KR); Joon-Soo Kim, Yongin-si (KR); Goo Soo Lee, Seoul (KR)

(21) Appl. No.: 16/757,126

(22) PCT Filed: Oct. 19, 2018
(86) PCT No.: PCT/US2018/056681

§ 371 Date: Apr. 17, 2020

(30) Foreign Application Priority Data
Oct. 20, 2017 (KR) 10-2017-0136431

(51) Int. Cl. B32B 7/12; B32B 7/022

(52) U.S. Cl. CPC B32B 7/12; B32B 2307/546; B32B 7/022

(57) ABSTRACT

A laminated glass structure is provided that includes: a substrate comprising a primary surface and a thickness from about 0.5 mm to about 50 mm; an adhesive having an elastic modulus, E_{adhesive}, of about 0.001 MPa to 0.2 MPa; and a flexible glass sheet having a thickness, t_{glass}, of no greater than about 300 μm. The flexible glass sheet is laminated to the primary surface of the substrate with the adhesive. Further, a thickness of the adhesive, t_{adhesive}, IS given by the following: t_{adhesive}>δ×AWt×(200\imlt_{glass})×(E_{adhesive} 10.1 MPa), where δ is a waviness constant set at 150 and AWt is a delta total waviness (μm), the delta total waviness, AWt, ranges from about 0.125 μιη to 2.5 μιη and is defined as the difference between a waviness of the substrate and a waviness of the glass sheet.

### CROSS-REFERENCE TO RELATED APPLICATIONS

This application claims the benefit of priority of Korean Patent Application Serial No. 10-2017-0136431 filed on Oct. 20, 2017, the contents of which are relied upon and incorporated herein by reference in their entirety as if fully set forth below.

### FIELD

The present disclosure relates to laminated glass structures and, more particularly, to laminated glass structures and articles configured for low waviness.

### BACKGROUND

Laminated glass structures may be used as components in the fabrication of various appliances, automobile components, architectural structures, and electronic devices, to name a few. For example, laminated glass structures may be incorporated as cover glass for various end products such as refrigerators, backsplashes, decorative glazing or televisions. Laminated glass structures can also be employed in laminated stacks for various architectural applications, decorative wall panels, panels designed for ease-of-cleaning and other laminate applications in which a thin glass surface is valued.

These laminated glass structures typically employ thin glass as a premium surface that is visually appealing, scratch resistant and easily cleanable. Owing to the optical clarity of many of these thin glasses, various aesthetic features can also be employed in the laminated structures beneath the glass. In these laminated glass structures, the substrate upon which the thin glass sits provides structural rigidity, decoration, and a mechanism for mounting to other structures (e.g., walls).

Unfortunately, conventional laminated glass structures can be prone to waviness and other distortions associated with their fabrication and/or the properties and dimensions of their constituents. In some instances, distortions, surface roughness and dimensional variability between the substrate, adhesive and outer glass surface manifest themselves as waviness and distortions in the outer glass. The waviness and distortions in the thin outer glass can result in an undesirable appearance and loss of optical clarity in the laminated structure. Further, efforts to address these problems have been limited to carefully adjusting the viscosity of the adhesive during manufacturing (e.g., by additional heating) in an effort to ‘smooth’ over roughness and other distortions in the substrate and bonding surface of the thin outer glass. Unfortunately, these efforts are often limited to the use of particular adhesives with low glass transition temperatures and substrate materials with high thermal stability. Further, these efforts related to adhesive viscosity control can add manufacturing cost given their reliance on additional process control during the lamination process.

Accordingly, there is a need for laminated glass structure and articles that are configured for low waviness. There is also a need for laminated glass structures and articles that are configured for low waviness without significant process dependencies.

### SUMMARY

According to a first aspect, a laminated glass structure is provided that includes: a substrate comprising a primary surface and a thickness from about 0.5 mm to about 50 mm; an adhesive having an elastic modulus, E_{adhesive}, of about 0.001 MPa to 0.2 MPa; and a flexible glass sheet having a thickness, t_{glass}, of no greater than about 300 μm. The flexible glass sheet is laminated to the primary surface of the substrate with the adhesive. Further, a thickness of the adhesive, t_{adhesive}, is given by the following: t_{adhesive}≥δ×ΔWt×(200 μm/t_{glass})×(E_{adhesive}/0.1 MPa), where δ is a waviness constant set at 150 and ΔWt is a delta total waviness (μm), the delta total waviness, ΔWt, ranges from about 0.125 μm to 2.5 μm and is defined as the difference between a waviness of the substrate and a waviness of the glass sheet.

According to a second aspect, the structure of aspect 1 is provided, wherein the thickness of the adhesive, t_{adhesive}, is from about 25 μm to 500 μm.

According to a third aspect, the structure of aspect 1 or 2 is provided, wherein the substrate comprises a material selected from the group consisting of a glass, a glass-ceramic, a ceramic, a polymer, a wood, a low pressure laminate (LPL), a high pressure laminate (HPL), a melamine-containing laminate, a particle-reinforced board, a fiber-reinforced board, and a medium density fiberboard (MDF).

According to a fourth aspect, the structure of any one of aspects 1-3 is provided, wherein the adhesive comprises an optically clear adhesive (OCA).

According to a fifth aspect, the structure of any one of aspects 1-4 is provided, wherein the elastic modulus of the adhesive, E_{adhesive}, is from about 0.01 MPa to 0.2 MPa.

According to a sixth aspect, the structure of any one of aspects 1-5 is provided, wherein an elastic modulus of the flexible glass sheet ranges from about 60 GPa to 90 GPa.

According to a seventh aspect, the structure of any one aspects 1-6 is provided, wherein the waviness of the flexible glass sheet is from about 0 μm to about 0.05 μm.

According to an eighth aspect, a laminated glass structure is provided that includes: a substrate comprising a primary surface and a thickness from about 0.5 mm to about 50 mm; an adhesive having an elastic modulus, E_{adhesive}, of about 0.001 MPa to 0.2 MPa; and a flexible glass sheet having a thickness, t_{glass}, of no greater than about 300 μm. The flexible glass sheet is laminated to the primary surface of the substrate with the adhesive. Further, a thickness of the adhesive, t_{adhesive}, is from about 25 μm to 500 μm and a total waviness, Wt, of the laminated glass structure is 200 nm or less, as measured on an exposed surface of the flexible glass sheet.

According to a ninth aspect, the structure of aspect 8 is provided, wherein the substrate comprises a material selected from the group consisting of a glass, a glass-ceramic, a ceramic, a polymer, a wood, a low pressure laminate (LPL), a high pressure laminate (HPL), a melamine-containing laminate, a particle-reinforced board, a fiber-reinforced board, and a medium density fiberboard (MDF).

According to a tenth aspect, the structure of any aspect 8 or 9 is provided, wherein the adhesive comprises an optically clear adhesive (OCA).

According to an eleventh aspect, the structure of any one of aspects 8-10 is provided, wherein the elastic modulus of the adhesive, E_{adhesive}, is from about 0.01 MPa to 0.2 MPa.

According to a twelfth aspect, the structure of any one of aspects 8-11 is provided, wherein an elastic modulus of the flexible glass sheet ranges from about 60 GPa to 90 GPa.

According to a thirteenth aspect, the structure of any one aspects 8-12 is provided, wherein the waviness of the flexible glass sheet is from about 0 μm to about 0.05 μm.

According to a fourteenth aspect, the structure of any one of aspects 8-13 is provided, wherein a total waviness, Wt, of the laminated glass structure is 200 nm or less, as measured on an exposed surface of the flexible glass sheet.

According to a fifteenth aspect, a laminated glass structure is provided that includes: a substrate comprising a primary surface and a thickness from about 0.5 mm to about 50 mm; an adhesive having an elastic modulus, E_{adhesive}, of about 0.001 MPa to 0.2 MPa; and a flexible glass sheet having a thickness, t_{glass}, of no greater than about 300 μm. The flexible glass sheet is laminated to the primary surface of the substrate with the adhesive. Further, a thickness of the adhesive, t_{adhesive}, is given by the following: t_{adhesive}≥δ×ΔWt×(200 μm/t_{glass})×(E_{adhesive}/0.1 MPa), where δ is a waviness constant set at 150 and ΔWt is a delta total waviness (μm), the delta total waviness, ΔWt, ranges from about 0.125 μm to 2.5 μm and is defined as the difference between a waviness of the substrate and a waviness of the glass sheet. In addition, a total waviness, Wt, of the laminated glass structure is 200 nm or less, as measured on an exposed surface of the flexible glass sheet.

According to a sixteenth aspect, the structure of aspect 15 is provided, wherein the substrate comprises a material selected from the group consisting of a glass, a glass-ceramic, a ceramic, a polymer, a wood, a low pressure laminate (LPL), a high pressure laminate (HPL), a melamine-containing laminate, a particle-reinforced board, a fiber-reinforced board, and a medium density fiberboard (MDF).

According to a seventeenth aspect, the structure of aspect 15 or aspect 16 is provided, wherein the adhesive comprises an optically clear adhesive (OCA).

According to an eighteenth aspect, the structure of any one of aspects 15-17 is provided, wherein the elastic modulus of the adhesive, E_{adhesive}, is from about 0.01 MPa to 0.2 MPa.

According to a nineteenth aspect, the structure of any one of aspects 15-18 is provided, wherein an elastic modulus of the flexible glass sheet ranges from about 60 GPa to 90 GPa.

According to a twentieth aspect, the structure of any one of aspects 15-19 is provided, wherein the waviness of the flexible glass sheet is from about 0 μm to about 0.05 μm.

Additional features and advantages will be set forth in the detailed description which follows, and in part will be readily apparent to those skilled in the art from the description or recognized by practicing the disclosure as exemplified in the written description and the appended drawings. It is to be understood that both the foregoing general description and the following detailed description are merely exemplary of the disclosure, and are intended to provide an overview or framework to understanding the nature and character of the disclosure as it is claimed.

The accompanying drawings are included to provide a further understanding of principles of the disclosure, and are incorporated in and constitute a part of this specification. The drawings illustrate one or more embodiment(s), and together with the description serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following aspects.

### BRIEF DESCRIPTION OF THE DRAWINGS

These and other features, aspects and advantages of the present disclosure are better understood when the following detailed description of the disclosure is read with reference to the accompanying drawings, in which:

FIG. 1 illustrates a cross-sectional view of a laminated glass structure, according to an example of the disclosure;

FIG. 2 is a plan view photograph of a conventional laminated glass structure with severe waviness indicated by a distorted, reflected image of a pair of fluorescent lamps;

FIG. 3 is a set of plan view photographs showing a reflected image of a pair of fluorescent lamps and plots of laminated structure height vs. length, indicative of total waviness, Wt, of a conventional laminated glass structure and a laminated glass structure according to the disclosure;

FIG. 4 is a set of plots of height vs. length for a flexible glass sheet (left-hand image) and a high-pressure laminate (HPL) substrate (right-hand image) that can be laminated with an adhesive such that the resultant, laminated glass structure has a low waviness, according to an aspect of the disclosure;

FIG. 5 is a plot of total waviness, Wt, of the laminated glass structure vs. OCA thickness for laminated glass structures with one of two types of an optically clear adhesive (OCA), according to aspects of the disclosure; and

FIG. 6 is a plot of load vs. expansion from testing of the two types of OCAs in the laminated glass structures of FIG. 5 with the ASTM D882 testing protocol, according to aspects of the disclosure.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

As used herein, the terms “total waviness,” “waviness” and “Wt” of a laminated glass structure, a flexible glass sheet or a substrate are used interchangeably and defined as the total distance of the largest profile peak height and the largest profile valley depth along a measurement length, for a particular surface of the laminated glass structure, flexible glass sheet or substrate. Unless otherwise noted, all such total waviness measurements in the disclosure were made with an Alpha-Step IQ surface profiler having a 10 mm measurement range (KLA-Tencor Corporation).

Disclosed herein are various laminated glass structures, designs and articles that are configured for low waviness. In general, the laminated glass structures include a substrate with a thickness from about 0.1 mm to about 100 mm, an adhesive having an elastic modulus of about 0.001 MPa to about 0.2 MPa and a flexible glass sheet having a thickness of no greater than about 300 μm. These elements are laminated such that the flexible glass sheet is laminated to a primary surface of the substrate with the adhesive. Further, the thickness and/or the elastic modulus of the adhesive can be controlled to ensure that the total waviness of the laminated glass structure is 200 nm or less, as measured on an exposed surface of the flexible glass sheet.

The laminated glass structures, designs and design approaches described herein offer several advantages over conventional glass laminates. For instance, the laminated glass structures of the disclosure offer significantly lower levels of waviness than their conventional counterparts. These improvements to the waviness of the laminated glass structure can enhance the aesthetics and the optical clarity of the structure. Another advantage of these laminated glass structures is that they are configured for low waviness through the selection of adhesives with particular elastic modulus values and/or thicknesses according to the principles of the disclosure, rather than a reliance on additional process steps (e.g., adhesive heating) and/or process controls (e.g., adhesive viscosity control) that, in some cases, can result in yield loss. Accordingly, the laminated glass structures of the disclosure can be produced with limited, additional process-related costs.

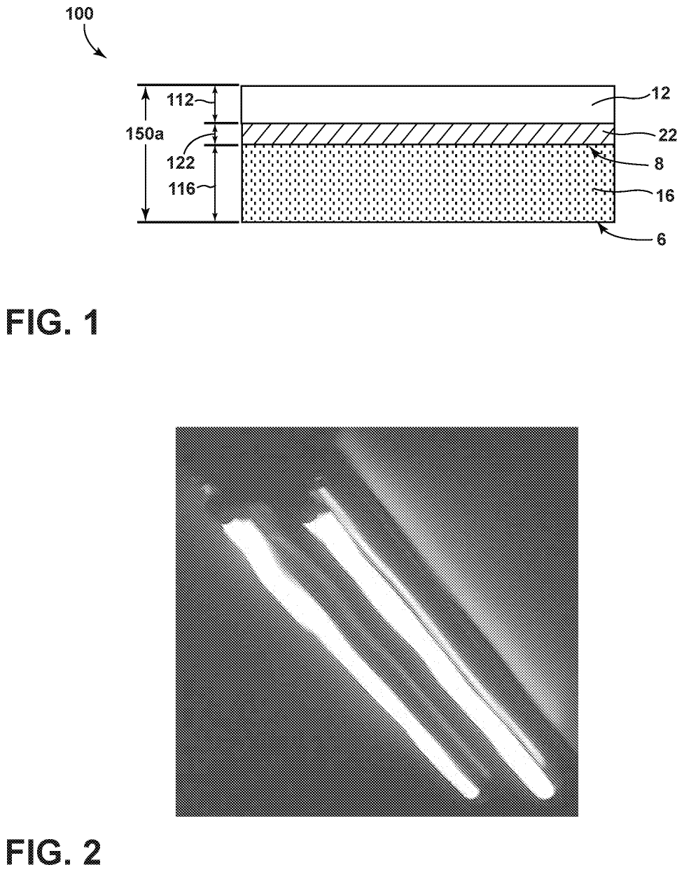

Referring now to FIG. 1, an exemplary, laminated glass structure 100a is provided according to an embodiment of the disclosure. The laminated glass structure 100a includes a substrate 16 having upper and lower primary surfaces 8, 6; a flexible glass sheet 12; and an adhesive 22. The substrate 16, flexible glass sheet 12 and adhesive 22 possess thicknesses 116, 112 and 122, respectively. Further, the laminated glass structure 100a has a total thickness 150a. As shown in FIG. 1, the flexible glass sheet 12 is laminated to the primary surface 8 of the substrate 16 with the adhesive 22. According to another embodiment (not shown), the flexible glass sheet 12 can be laminated to the primary surface 6 of the substrate 16 with the adhesive 22. In a further implementation (not shown), a flexible glass sheet 12 is laminated to each of the primary surfaces 6, 8 of the substrate 16 with separate adhesives 22, resulting in a laminated glass structure 100a with a pair of flexible glass sheets 12.

In certain implementations of the laminated glass structure 100a depicted in FIG. 1, the substrate 16 has a thickness 116 from about 0.5 mm to about 50 mm and primary surfaces 6, 8, each with a surface area of at least 1 m². The flexible glass sheet 12 has a thickness 112 of no greater than 0.3 mm (i.e., no greater than 300 μm).

Referring again to FIG. 1, the laminated glass structure 100a can, in some embodiments, include an adhesive 22 having an elastic modulus, E_{adhesive}, of about 0.001 MPa to about 0.2 MPa. Further, a thickness 122 of the adhesive 22, t_{adhesive}, is from about 25 μm to 500 μm. In addition, the laminated glass structure 100a is configured with a low waviness, e.g., through the selection of thickness 122 and elastic modulus of the adhesive 22, particularly adhesives 22 with higher thicknesses 122 (e.g., a thickness of ≥ about 50 μm) and/or lower elastic modulus (e.g., an elastic modulus of ≤0.1 MPa). In particular, the total waviness, Wt, of the laminated glass structure 100a can be 200 nm or less, as measured on an exposed surface of the flexible glass sheet 12. Further, in some aspects, the total waviness, Wt, of the laminated glass structure 100a can be 100 nm or less, as measured on an exposed surface of the flexible glass sheet 12. The total waviness, Wt, of the laminated glass structure 100a can be about 200 nm or less, 190 nm or less, 180 nm or less, 170 nm or less, 160 nm or less, 150 nm or less, 140 nm or less, 130 nm or less, 120 nm or less, 110 nm or less, 100 nm or less, 90 nm or less, 80 nm or less, 70 nm or less, 60 nm or less, 50 nm or less, 40 nm or less, 30 nm or less, 20 nm or less, or even 10 nm or less.

According to another embodiment of the laminated glass structure 100a depicted in FIG. 1, the structure 100a includes: a substrate 16 comprising a primary surface 8 and a thickness 116 from about 0.5 mm to about 50 mm; an adhesive 22 having an elastic modulus, E_{adhesive}, of about 0.001 MPa to 0.2 MPa; and a flexible glass sheet 12 having a thickness 112, t_{glass}, of no greater than about 300 μm. The flexible glass sheet 12 is laminated to the primary surface 8 of the substrate 16 with the adhesive 22. Further, a thickness 122 of the adhesive 22, t_{adhesive}, is given by the following: t_{adhesive}≥δ×ΔWt×(200 μm/t_{glass})×(E_{adhesive}/0.1 MPa), where δ is a waviness constant equal to 150 and ΔWt is a delta total waviness (μm), the delta total waviness, ΔWt, ranges from about 0.125 μm to 2.5 μm and is defined as the difference between a waviness, Wt, of the substrate 16 and a waviness, Wt, of the glass sheet 12 (“Equation 1”). Accordingly, in some aspects of these laminated glass structures 100a, the thickness 122 of the adhesive 22 is set as a function of the thickness 112 of the glass sheet 12 and the elastic modulus of the adhesive 22.

According to a further embodiment of the laminated glass structure 100a (see FIG. 1), the structure 100a includes: a substrate 16 comprising a primary surface 8 and a thickness 116 from about 0.5 mm to about 50 mm; an adhesive 22 having an elastic modulus, E_{adhesive}, of about 0.001 MPa to 0.2 MPa; and a flexible glass sheet 12 having a thickness 112, t_{glass}, of no greater than about 300 μm. The flexible glass sheet 12 is laminated to the primary surface 8 of the substrate 16 with the adhesive 22. Further, a thickness 122 of the adhesive 22, t_{adhesive}, is given by the following according to Equation 1: t_{adhesive}≥δ×ΔWt×(200 μm/t_{glass})×(E_{adhesive}/0.1 MPa), where δ is a waviness constant equal to 150 and ΔWt is a delta total waviness (μm), the delta total waviness, ΔWt, ranges from about 0.125 μm to 2.5 μm and is defined as the difference between a waviness (Wₜ) of the substrate 16 and a waviness (Wₜ) of the glass sheet 12. In addition, a total waviness, Wt, of the laminated glass structure 100a of this embodiment is 200 nm or less, as measured on an exposed surface of the flexible glass sheet 12. Hence, in some aspects of these laminated glass structures 100a, the thickness 122 of the adhesive 22 is set as a function of the thickness 112 of the glass sheet 12 and the elastic modulus of the adhesive 22 to control the total waviness, Wt, of the laminated glass structure 100a of this embodiment is 200 nm or less, or 100 nm or less in some cases, as measured from an exposed surface of the glass sheet 12. As such, the total waviness, Wt, of these laminated glass structures 100a can be about 200 nm or less, 190 nm or less, 180 nm or less, 170 nm or less, 160 nm or less, 150 nm or less, 140 nm or less, 130 nm or less, 120 nm or less, 110 nm or less, 100 nm or less, 90 nm or less, 80 nm or less, 70 nm or less, 60 nm or less, 50 nm or less, 40 nm or less, 30 nm or less, 20 nm or less, or even 10 nm or less.

Within the laminated glass structure 100a depicted in FIG. 1, the substrate 16 can be fabricated from non-glass materials, many of which are hygroscopic and/or susceptible to containing volatiles after manufacturing. Particular examples of the material employed in the substrate 16 include but are not limited to wood, fiberboard, drywall, laminate, composite, polymeric, metal, metal alloy and/or stone materials. The metal alloys include but are not limited to stainless steel, aluminum, nickel, magnesium, brass, bronze, titanium, tungsten, copper, cast iron, ferrous steels, and noble metals. The substrate 16 may also include glass, glass-ceramic and/or ceramic materials as secondary constituents, e.g., fillers. In some embodiments, the substrate 16 includes polymer, wood or wood-based products such as chipboard, particleboard, fiberboard, cardboard, hardboard, or paper. For example, the substrate 16 can comprise a low pressure laminate (LPL), a high pressure laminate (HPL), medium density fiberboard (MDF) and/or a veneer. In other aspects of the disclosure, the substrate 16 is selected from the foregoing materials to provide support for the flexible glass sheet 12 and/or to provide a suitable structure for the installation of connectors and other hardware to mount the laminated glass structure 100a to a wall, ceiling or other application-oriented fixture.

As also depicted in FIG. 1, the substrate 16 has a thickness 116 within the laminated glass structure 100a. In certain embodiments, the thickness 116 ranges from about 0.1 mm to about 100 mm and, preferably, from about 0.5 mm to about 50 mm. In certain other aspects, the thickness 116 of the substrate 16 ranges from about 2.5 mm to about 25 mm. For example, the thickness 116 can be about 0.5 mm, 1.0 mm, 1.5 mm, 2.0 mm, 2.5 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 35 mm, 40 mm, 45 mm, 50 mm, and all thickness values between these thicknesses.

In certain embodiments of the laminated glass structure 100a depicted in FIG. 1, the substrate 16 may be formed using a polymer material, for example, any one or more of polyethylene teraphthalate (PET), polyethylene Naphthalate (PEN), ethylene tetrafluoroethylene (ETFE), or thermopolymer polyolefin (TPO™—polymer/filler blends of polyethylene, polypropylene, block copolymer polypropylene (BCPP), or rubber), polyesters, polycarbonate, polyvinylbuterate, polyvinyl chloride, polyethylene and substituted polyethylenes, polyhydroxybutyrates, polyhydroxyvinylbutyrates, polyetherimides, polyamides, polyethylenenaphalate, polyimides, polyethers, polysulphones, polyvinylacetylenes, transparent thermoplastics, transparent polybutadienes, polycyanoacrylates, cellulose-based polymers, polyacrylates and polymethacrylates, polyvinylalcohol, polysulphides, polyvinyl butyral, polymethyl methacrylate and polysiloxanes. It is also possible to use polymers which can be deposited and/or coated as pre-polymers or pre-compounds and then converted, such as epoxy-resins, polyurethanes, phenol-formaldehyde resins, and melamine-formaldehyde resins. Many display and electrical applications may prefer acrylic-based polymers, silicones and such structural aiding layers, for example, commercially available SentryGlas® from DuPont. The polymer layers may be transparent for some applications, but need not be for other applications.

Referring again to FIG. 1, the flexible glass sheet 12 may be formed of glass, a glass ceramic, a ceramic material or composites thereof. A fusion process (e.g., a downdraw process) that forms high quality flexible glass sheets can be used in a variety of devices, and one such application is flat panel displays. Glass sheets produced in a fusion process have surfaces with superior flatness and smoothness when compared to glass sheets produced by other methods. The fusion process is described in U.S. Pat. Nos. 3,338,696 and 3,682,609, the disclosures of which are hereby incorporated by reference. Other suitable glass sheet forming methods include a float process, updraw and slot draw methods. Additionally, the flexible glass sheet 12 may also contain anti-microbial properties by using a chemical composition for the glass that includes, or otherwise incorporates, a silver ion concentration on the surface of the glass sheet, for example, in the range from greater than 0 to 0.047 μg/cm², as further described in U.S. Pat. No. 8,973,401, the disclosure of which is hereby incorporated by reference. The flexible glass sheet 12 may also be coated with a glaze composed of silver, or otherwise doped with silver ions, to gain the desired anti-microbial properties, as further described in U.S. Patent Application Publication No. 2011/0081542, the disclosure of which is hereby incorporated by reference. Additionally, the flexible glass sheet 12 may have a molar composition of 50% SiO₂, 25% CaO, and 25% Na₂O to achieve the desired anti-microbial properties.

As depicted in FIG. 1, the flexible glass sheet 12 of the laminated glass structure 100a has a thickness 112. In certain aspects of the laminated glass structure 100a, the thickness 112 of the flexible glass sheet 12 is about 0.3 mm or less including but not limited to thicknesses of, for example, about 0.01-0.05 mm, about 0.05-0.1 mm, about 0.1-0.15 mm, about 0.15-0.3 mm, or about 0.1 to about 0.2 mm. The thickness 112 of the flexible glass sheet 12 can also be about 0.3 mm, 0.275 mm, 0.25 mm, 0.225 mm, 0.2 mm, 0.19 mm, 0.18 mm, 0.17 mm, 0.16 mm, 0.15 mm, 0.14 mm, 0.13 mm, 0.12 mm, 0.11 mm, 0.10 mm, 0.09 mm, 0.08 mm, 0.07 mm, 0.06 mm, 0.05 mm, 0.04 mm, 0.03 mm, 0.02 mm, 0.01 mm, or any thickness value between these thicknesses. In some implementations of the laminated glass structure 100a, the total waviness, Wt, of the flexible glass sheet 12 should be minimized, preferably from 0 μm to about 0.05 μm. Further, in some embodiments of the laminated glass structure 100a, the flexible glass sheet 12 can have an elastic modulus of about 60 GPa to about 90 GPa, or about 70 GPa to about 80 GPa in some cases.

As further depicted in FIG. 1, the laminated glass structure 100a includes an adhesive 22 that can be employed to laminate the flexible glass sheet 12 to the upper primary surface 8 of the substrate 16. The adhesive 22 may be a non-adhesive interlayer, an adhesive, a sheet or film of adhesive, a liquid adhesive, a powder adhesive, an optically clear adhesive (OCA), a pressure sensitive adhesive, an ultraviolet-light curable adhesive, a thermally curable adhesive, or other similar adhesive or combination thereof. The adhesive 22 may also assist in attaching the flexible glass sheet 12 to the substrate 16 during and/or prior to a lamination process step. Some examples of low temperature adhesive materials include Norland Optical Adhesive 68 (Norland Products, Inc.) cured by ultra-violet (UV) light, FLEXcon V29TT adhesive, 3M™ optically clear adhesive 8211, 8212, 8214, 8215, 8146, 8171, and 8172 (bonded by pressure at room temperature or above), 3M™ 4905 tape, OptiClear® adhesive, silicones, acrylates, optically clear adhesives, encapsulant material, polyurethane polyvinylbutyrates, ethylenevinylacetates, ionomers, and wood glues. Typical graphic adhesives such as Graphicmount and Facemount may also be used (as available from LexJet Corporation, located in Sarasota, Fla., for example). Some examples of higher temperature adhesive materials include DuPont SentryGlas®, DuPont PV 5411, Japan World Corporation material FAS and polyvinyl butyral resin.

Again as shown in FIG. 1, the adhesive 22 may be thin, having a thickness 122 of less than or equal to about 500 μm, about 250 μm, less than or equal to about 50 μm, or less than or equal to 40 μm. Further, the thickness 122 of the adhesive 22 is greater than about 25 μm, according to embodiments. In other aspects, the thickness 122 of the adhesive 22 is from about 0.025 mm to about 0.5 mm. The adhesive 22 may also contain other functional components such as color, decoration, heat or UV resistance, AR filtration, etc. The adhesive 22 may be optically clear on cure, or it may otherwise be opaque. For those embodiments in which the adhesive 22 comprises a sheet or film of adhesive, the adhesive 22 may have a decorative pattern or design that is visible through the thickness 112 of the flexible glass sheet 12. Similarly, to the extent that the substrate 16 has clarity, the adhesive 22 may also have a decorative pattern or design that is visible through the thickness 116 of the substrate 16.

As also depicted in FIG. 1, the adhesive 22 of the laminated glass structure 100a can be formed of a liquid, gel, sheet, film or a combination of these forms. Further, in some aspects, the adhesive 22 can exhibit a pattern of stripes that are visible from an outer surface of the flexible glass sheet 12 and/or substrate 16, provided that it has sufficient optical clarity. In some embodiments, the substrate 16 and/or the flexible glass sheet 12 may include a decorative pattern. In some embodiments, the decorative pattern may be provided within multiple layers, e.g., within the flexible glass sheet 12, substrate 16 and/or adhesive 22.

The adhesive 22 of the laminated glass structure 100a depicted in FIG. 1 can, in some embodiments, have an elastic modulus from about 0.001 MPa to about 0.2 MPa. In some aspects, the adhesive 22 is selected with an elastic modulus from about 0.001 MPa to about 0.1 MPa, or from about 0.001 MPa to about 0.07 MPa. Accordingly, in some aspects of the laminated glass structure 100a, the adhesive 22 can have an elastic modulus of about 0.2 MPa or less, 0.19 MPa or less, 0.18 MPa or less, 0.17 MPa or less, 0.19 MPa or less, 0.18 MPa or less, 0.17 MPa or less, 0.16 MPa or less, 0.15 MPa or less, 0.14 MPa or less, 0.13 MPa or less, 0.12 MPa or less, 0.11 MPa or less, 0.1 MPa or less, 0.09 MPa or less, 0.08 MPa or less, 0.07 MPa or less, 0.06 MPa or less, 0.05 MPa or less, and all adhesives 22 with elastic modulus values between these levels.

Referring again to FIG. 1, the overall thickness 150a of the laminated glass structure 100a can range from about 0.1 mm to about 100 mm, preferably from about 0.5 mm to about 50 mm. In particular, the overall thickness of the laminated glass structure 100a is given by the sum of the thicknesses 112, 116 and 122 of the flexible glass sheet 12, substrate 16, and adhesive 22, respectively. Accordingly, the overall thickness of the laminated glass structure 100a can be about 0.1 mm, 0.5 mm, 1 mm, 1.5 mm, 2.0 mm, 2.5 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 40 mm, 45 mm, 50 mm, 55 mm, 60 mm, 70 mm, 80 mm, 90 mm, 100 mm, and all thickness values between these overall thicknesses.

In some embodiments, the total waviness, Wt, of the laminated glass structure 100a (see FIG. 1) can be 200 nm or less, as measured on an exposed surface of the flexible glass sheet 12. Further, in some aspects, the total waviness, Wt, of the laminated glass structure 100a can be 150 nm or less, 100 nm or less, or 75 nm or less, as measured on an exposed surface of the flexible glass sheet 12. The total waviness, Wt, of the laminated glass structure 100a can be about 200 nm or less, 190 nm or less, 180 nm or less, 170 nm or less, 160 nm or less, 150 nm or less, 140 nm or less, 130 nm or less, 120 nm or less, 110 nm or less, 100 nm or less, 90 nm or less, 80 nm or less, 70 nm or less, 60 nm or less, 50 nm or less, 40 nm or less, 30 nm or less, 20 nm or less, or even 10 nm or less.

With regard to processing of the laminated glass structures 100a (see FIG. 1) consistent with the principles of the disclosure, those with ordinary skill in the art can readily appreciate that various lamination methods can be employed to fabricate these structures. For example, high pressure and low pressure lamination approaches can be employed that are comparable to those typically used with conventional laminates, depending on the composition of the substrate 16 and other elements of the laminated glass structures 100a. In certain embodiments of the methods employed to fabricate the laminated glass structures 100a, various surface treatments (e.g., plasma cleaning, etching, polishing and others) can be applied to the primary surface 8 of the substrate 16 to facilitate improved lamination with the flexible glass sheet 12 by the adhesive 22.

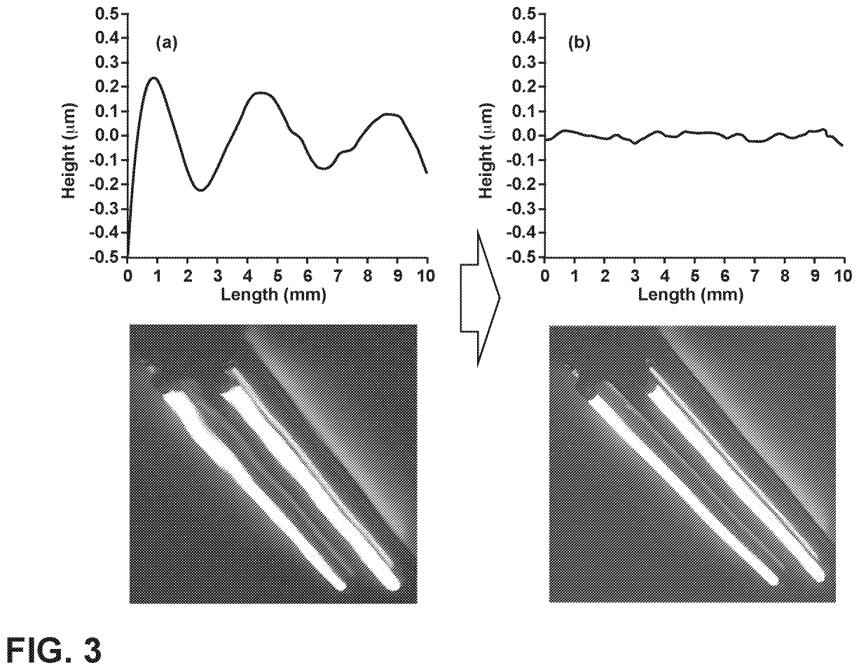

Still referring to FIG. 1, the laminated glass structure 100a can be generally configured for low waviness (e.g., as relative to conventional laminates) through relatively higher thicknesses 122 of the adhesive 22 (e.g., a thickness of ≥ about 50 μm), lower elastic modulus of the adhesive 22 (e.g., an elastic modulus of ≤0.1 MPa), and/or lower total waviness, Wt, of the flexible glass sheet 12 (e.g., from about 0 μm to about 0.05 μm). Accordingly, in some aspects, the laminated glass structures 100a of the disclosure can be characterized by significantly lower levels of total waviness as compared to the levels of total waviness exhibited by conventional glass laminates, e.g., as depicted in FIG. 2 (i.e., a plan view photograph of a conventional laminated glass structure with severe waviness indicated by a distorted, reflected image of a pair of fluorescent lamps). For example, FIGS. 3A and 3B include a set of plan view photographs of a reflected image of a pair of fluorescent lamps generated from light exposure from the lamps on a conventional laminated glass structure (FIG. 3A) with a 25 μm thick OCA with an elastic modulus of about 0.059 MPa, an HPL substrate and a 200 μm thick flexible glass sheet, and a laminated glass structure 100a according to the disclosure (FIG. 3B) with a 175 μm thick OCA with an elastic modulus of about 0.059 MPa, an HPL substrate and a 200 μm thick flexible glass sheet, respectively. It is apparent from the photographs in FIGS. 3A and 3B that the pair of fluorescent lamps reflected in the laminated glass structure 100a is depicted with a high degree of sharpness as compared to the same lamps reflected in the conventional laminated glass structure. FIGS. 3A and 3B also demonstrate this effect quantitatively. In particular, FIGS. 3A and 3B include plots of laminated structure height (μm) vs. sample length (mm), which is indicative of total waviness, Wt, of the same conventional laminated glass structure (with a total waviness, Wt=516.8 nm) and a laminated glass structure 100a according to the disclosure (with a total waviness, Wt=51.6 nm).

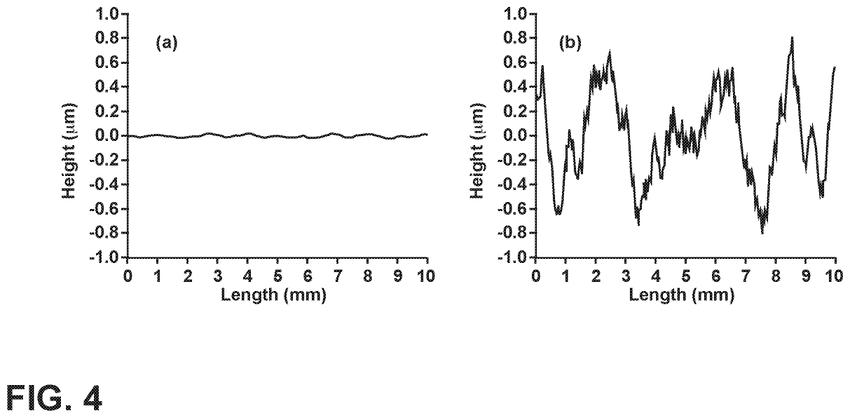

Referring now to FIG. 4, a set of plots of height (μm) vs. sample length (mm) for an exemplary flexible glass sheet (left-hand image) and an exemplary high-pressure laminate (HPL) substrate (right-hand image) of the disclosure are provided (e.g., a flexible glass sheet 12 and a substrate 16, respectively, as shown in FIG. 1). As is evident from FIG. 4, the total waviness, Wt, of the flexible glass sheet and the HPL is 35.1 nm and 1380.8 nm, respectively, as determined from the reported height values. Further, the glass sheet and HPL depicted in FIG. 4 can be laminated with an adhesive (e.g., an adhesive 22 as shown in FIG. 1) such that the resultant, laminated glass structure (e.g., laminated glass structure 100a as shown in FIG. 1) has a low waviness, Wt, according to an aspect of the disclosure. For example, the flexible glass sheet with a thickness of 200 μm and an HPL substrate as depicted in FIG. 4 can be laminated with an adhesive having an elastic modulus of about 0.059 MPa; consequently, the thickness of the adhesive can be held to a thickness of 119.1 μm or greater according to Equation 1. That is, the thickness of the adhesive, t_{adhesive}≥δ [set at 150]×ΔWt [1380.8 nm−35.1 nm]×(200 μm/t_{glass} [200 μm])×(E_{adhesive} [0.059 MPa]/0.1 MPa)=119.1 μm.

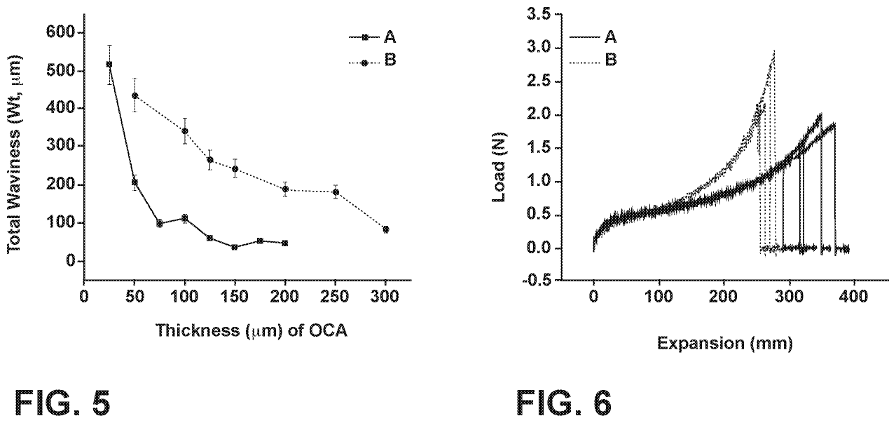

Referring now to FIG. 5, a plot of total waviness, Wt (nm), vs. OCA thickness (μm) for laminated glass structures with one of two types of an OCA adhesive (e.g., adhesive A and B) is provided, according to aspects of the disclosure. In FIG. 5, the OCA adhesives A and B are characterized by elastic modulus values of 0.059 MPa and 0.072 MPa, respectively. Each of these elastic modulus values was obtained from the load (N) vs. expansion (i.e., displacement) curves shown in FIG. 6 through calculation and analysis techniques as understood by those with ordinary skill in the field of this disclosure. That is, the OCA adhesives A and B in the laminated glass structures of FIG. 5 were tested with the ASTM D882 testing protocol to develop the load vs. expansion curves shown in FIG. 6. Referring back to FIG. 5, it is evident that the total waviness, Wt, of the laminated glass structure decreases with increasing thickness of the adhesive. As is also evident from FIG. 5, the total waviness, Wt, of the laminated glass structure decreases with decreasing elastic modulus of the adhesive employed in the laminate. These results are manifested in Equation 1, which can be employed according to aspects of the disclosure to control the total waviness of the laminated glass structures to levels of 200 nm or less through relatively higher thicknesses of the adhesive (e.g., a thickness of ≥ about 50 μm), minimization of the elastic modulus of the adhesive (e.g., an elastic modulus of ≤0.1 MPa), and/or reductions in the total waviness, Wt, of the flexible glass sheet (e.g., from about 0 μm to about 0.05 μm).

It should be emphasized that the above-described embodiments of the present disclosure, including any embodiments, are merely possible examples of implementations, merely set forth for a clear understanding of various principles of the disclosure. Many variations and modifications may be made to the above-described embodiments of the disclosure without departing substantially from the spirit and various principles of the disclosure. More generally, all such modifications and variations are intended to be included herein within the scope of this disclosure and protected by the following claims.

1. A laminated glass structure, comprising:
a substrate comprising a primary surface and a thickness from about 0.5 mm to about 50 mm;
an adhesive having an elastic modulus, E_{adhesive}, of about 0.001 MPa to 0.2 MPa; and
a flexible glass sheet having a thickness, t_{glass}, of no greater than about 300 μm,
wherein the flexible glass sheet is laminated to the primary surface of the substrate with the adhesive, and
further wherein a thickness of the adhesive, t_{adhesive}, is given by the following:
t_{adhesive}≥δ×ΔWt×(200 μm/t_{glass})×(E_{adhesive}/0.1 MPa),
where δ is a waviness constant equal to 150, and ΔWt is a difference between a waviness of the substrate and a waviness of the glass sheet given in μm and ranges from about 0.125 μm to 2.5 μm, wherein each of the waviness of the substrate and the waviness of the glass sheet is measured with an Alpha-Step IQ surface profiler having a 10 mm measurement range.

2. The structure according to claim 1, wherein the thickness of the adhesive, t_{adhesive}, is from about 25 μm to 500 μm.

3. The structure according to claim 1, wherein the substrate comprises a material selected from the group consisting of a glass, a glass-ceramic, a ceramic, a polymer, a wood, a low pressure laminate (LPL), a high pressure laminate (HPL), a melamine-containing laminate, a particle-reinforced board, a fiber-reinforced board, a medium density fiberboard (MDF), and combinations thereof.

4. The structure according to claim 1, wherein the adhesive comprises an optically clear adhesive (OCA).

5. The structure according to claim 1, wherein the elastic modulus of the adhesive, E_{adhesive}, is from about 0.01 MPa to 0.2 MPa.

6. The structure according to claim 1, wherein an elastic modulus of the flexible glass sheet ranges from about 60 GPa to 90 GPa.

7. The structure according to claim 1, wherein the waviness of the flexible glass sheet is from about 0 μm to about 0.05 μm.

8. A laminated glass structure, comprising:
a substrate comprising a primary surface and a thickness from about 0.5 mm to about 50 mm;
an adhesive having an elastic modulus, E_{adhesive}, of about 0.001 MPa to 0.2 MPa; and
a flexible glass sheet having a thickness, t_{glass}, of no greater than about 300 μm,
wherein the flexible glass sheet is laminated to the primary surface of the substrate with the adhesive,
wherein a thickness of the adhesive, t_{adhesive}, is from about 25 μm to 500 μm, and
wherein a total waviness, Wt, of the laminated glass structure is 200 nm or less, as measured on an exposed surface of the flexible glass sheet.

9. The structure according to claim 8, wherein the substrate comprises a material selected from the group consisting of a glass, a glass-ceramic, a ceramic, a polymer, a wood, a low pressure laminate (LPL), a high pressure laminate (HPL), a melamine-containing laminate, a particle-reinforced board, a fiber-reinforced board, a medium density fiberboard (MDF), and combinations thereof.

10. The structure according to claim 8, wherein the adhesive comprises an optically clear adhesive (OCA).

11. The structure according to claim 1, wherein the elastic modulus of the adhesive, E_{adhesive}, is from about 0.01 MPa to 0.2 MPa.

12. The structure according to claim 8, wherein an elastic modulus of the flexible glass sheet ranges from about 60 GPa to 90 GPa.

13. The structure according to claim 8, wherein the waviness of the flexible glass sheet is from about 0 μm to about 0.05 μm.

14. The structure according to claim 8, wherein a total waviness, Wt, of the laminated glass structure is 100 nm or less, as measured on an exposed surface of the flexible glass sheet.

15. A laminated glass structure, comprising:
a substrate comprising a primary surface and a thickness from about 0.5 mm to about 50 mm;
an adhesive having an elastic modulus, E_{adhesive}, of about 0.001 MPa to 0.2 MPa; and
a flexible glass sheet having a thickness, t_{glass}, of no greater than about 300 μm,
wherein the flexible glass sheet is laminated to the primary surface of the substrate with the adhesive,
wherein a total waviness, Wt, of the laminated glass structure is 200 nm or less, as measured on an exposed surface of the flexible glass sheet, and
wherein a thickness of the adhesive, t_{adhesive}, is given by the following:
t_{adhesive}≥δ×ΔWt×(200 μm/t_{glass})×(E_{adhesive}/0.1 MPa),
where δ is a waviness constant equal to 150, and ΔWt is a difference between a waviness of the substrate and a waviness of the glass sheet given in μm and ranges from about 0.125 μm to 2.5 μm.

16. The structure according to claim 15, wherein the substrate comprises a material selected from the group consisting of a glass, a glass-ceramic, a ceramic, a polymer, a wood, a low pressure laminate (LPL), a high pressure laminate (HPL), a melamine-containing laminate, a particle-reinforced board, a fiber-reinforced board, a medium density fiberboard (MDF), and combinations thereof.

17. The structure according to claim 15, wherein the adhesive comprises an optically clear adhesive (OCA).

18. The structure according to claim 15, wherein the elastic modulus of the adhesive, E_{adhesive}, is from about 0.01 MPa to 0.2 MPa.

19. The structure according to claim 15, wherein an elastic modulus of the flexible glass sheet ranges from about 60 GPa to 90 GPa.

20. The structure according to claim 15, wherein the waviness of the flexible glass sheet is from about 0 μm to about 0.05 μm.
